(19) United States
(12) Patent Application Publication
(10) Pub. No.: US 2014/0181822 A1
(43) Pub. Date: Jun. 26, 2014

(54) Fragmented Channels

(71) Applicant: ADVANCED MICRO DEVICES, INC., Sunnyvale, CA (US)

(72) Inventors: Bradford M. BECKMANN, Redmond, WA (US); Marc S. Orr, Renton, WA (US)

(73) Assignee: Advanced Micro Devices, Inc., Sunnyvale, CA (US)

(21) Appl. No.: 13/721,219

(22) Filed: Dec. 20, 2012

(51) Int. Cl. G06F 9/46

(52) U.S. Cl. CPC G06F 9/46
USPC 718/102

(57) ABSTRACT

A system, method and a computer-readable medium for task scheduling using fragmented channels is provided. A plurality of fragmented channels are stored in memory accessible to a plurality of compute units. Each fragmented channel is associated with a particular compute unit. Each fragmented channel also stores a plurality of data items from tasks scheduled for processing on the associated compute unit and links to another fragmented channel in the plurality of fragmented channels.

### BACKGROUND

1. Field

The embodiments are generally directed to using channels in a heterogeneous system environment, and specifically to task scheduling using fragmented channels.

2. Background Art

In a multi-core processing environment that includes multiple processors, such as central processing units (CPUs) and graphics processing units (GPUs) that process data in parallel, efficient task scheduling is necessary to process tasks. Typically, tasks that require processing are produced by producers located on CPUs or GPUs. Producers store tasks in global memory. A scheduler then schedules tasks stored in the global memory for processing by multiple compute units in the GPUs or by CPUs. Conventionally, producers and compute units use atomic operations to access the global memory to store or remove tasks. Because multiple compute units attempt to gain access to the global memory via atomic operations, the global memory becomes a highly contested resource. A contested global memory becomes a bottleneck in a multi-core processing environment where multiple processors attempt to access and process data in parallel.

### BRIEF SUMMARY OF EMBODIMENTS

A system, method and a computer-readable medium for task scheduling using fragmented channels is provided. A plurality of fragmented channels are stored in memory accessible to a plurality of compute units. Each fragmented channel is associated with a particular compute unit. Each fragmented channel also stores a plurality of data items from tasks scheduled for processing on the associated compute unit and links to another fragmented channel in the plurality of fragmented channels.

Further features and advantages of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the embodiments and, together with the description, further serve to explain the principles of the embodiments and to enable a person skilled in the pertinent art to make and use the embodiments. Various embodiments are described below with reference to the drawings, wherein like reference numerals are used to refer to like elements throughout.

FIG. 1 is a block diagram of a multi-core processing environment, according to an embodiment.

FIG. 2 is a block diagram of a channel configured to store tasks, according to an embodiment.

FIG. 3 is a block diagram of a channel comprising multiple fragmented channels, according to an embodiment.

FIG. 4 is a flowchart of a method for processing tasks using fragmented channels, according to an embodiment.

The embodiments will be described with reference to the accompanying drawings. Generally, the drawing in which an element first appears is typically indicated by the leftmost digit(s) in the corresponding reference number.

### DETAILED DESCRIPTION OF EMBODIMENTS

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment it is submitted that it is within the knowledge of one skilled in the art to affect such feature, structure, or characteristic in connection with other embodiments whether or not explicitly described.

The term “embodiments” does not require that all embodiments include the discussed feature, advantage or mode of operation. Alternate embodiments may be devised without departing from the scope of the disclosure, and well-known elements of the disclosure may not be described in detail or may be omitted so as not to obscure the relevant details. In addition, the terminology used herein is for the purpose of describing particular embodiments only and is not intended to be limiting of the disclosure. For example, as used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

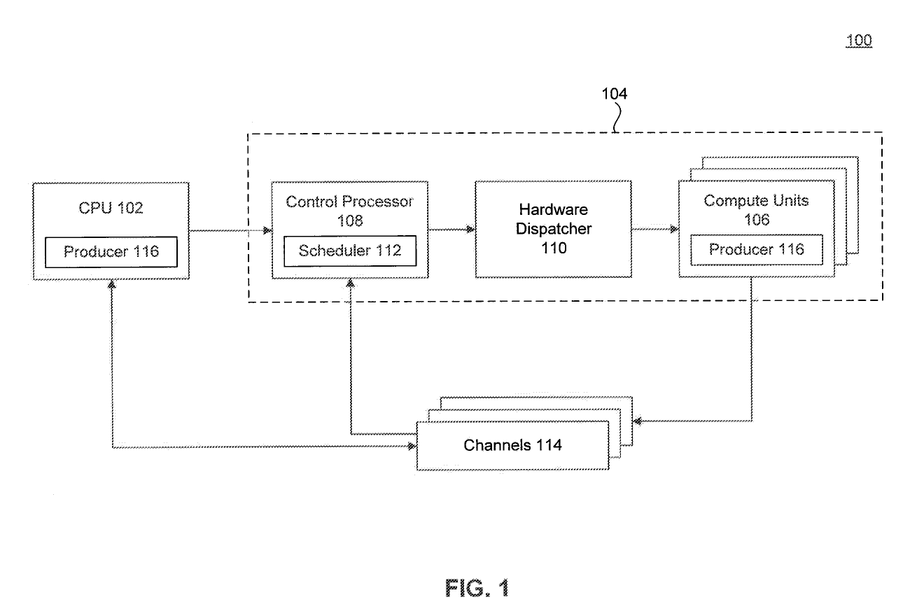

FIG. 1 is a block diagram of a multi-core processing environment 100, according to an embodiment. Multi-core processing environment 100 includes a central processing unit (CPU) 102 and graphics processing unit (GPU) 104.

CPU 102 is a piece of hardware within an electronic device which carries out instructions of computer programs or applications. CPU 102 carries out instructions by performing arithmetical, logical and input/output operations of the computer programs or applications. In an embodiment, CPU 102 performs control instructions that include decision making code of a computer program or an application.

GPU 104 is a piece of hardware that is a specialized electronic circuit designed to rapidly process mathematically intensive applications on electronic devices. Example electronic devices include, but are not limited to, mobile phones, personal computers, workstations, and game consoles. GPU 104 has a highly parallel structure that is efficient for parallel processing of large blocks of data, such as mathematically intensive data common to computer graphics applications, images and videos. In an embodiment, GPU 104 may form part of a larger processing unit which may also include CPU 102. In the art, such a combined processing unit may be referred to as an applications processor, an accelerated processing unit or, simply, a processor.

GPU 104 includes one or more compute units (CUs) 106. CUs 106 include arithmetic logic units (ALU's) that process tasks on GPU 104. A task includes work that comprises instructions and data for processing on CUs 106. Thus, when CU 106 receives a task, it extracts the data and instructions from the task and processes the data in the tasks according to the extracted instructions.

A command processor (CP) 108 on GPU 104 schedules tasks for processing using CUs 106. Once scheduled, hardware dispatcher 110 dispatches the scheduled tasks to a hardware pipeline. When CUs 106 are ready to process the task, CUs 106 read or de-queue the task from the hardware pipeline and execute the task.

To schedule tasks, CP 108 includes a scheduler 112. Scheduler 112 monitors work that requires processing by CUs 106. Once scheduler 112 makes a scheduling decision to process work, scheduler 112 creates a task that includes the work. In one embodiment, scheduler 112 may create a task when an amount of data reaches a predetermined threshold. A task may include one or more data items. A data item is a distinct unit of work that is performed by CU 106. Once scheduler creates a task, scheduler 112 then schedules the task for processing on a hardware pipeline.

In an embodiment, a developer may design scheduling programs to schedule tasks for processing on GPU 104. These scheduling programs are accessible to scheduler 112. The scheduling programs cause scheduler 112 to implement task scheduling that is optimized for a particular computer program or an application.

Hardware dispatcher 110 controls tasks scheduled in the hardware pipeline. For example, once scheduler 112 en-queues tasks to hardware pipeline, hardware dispatcher 110 determines when to de-queue tasks for processing by CUs 106. Once hardware dispatcher 110 de-queues tasks in hardware queue, CUs 106 read the instructions included in the tasks and execute the data in the tasks according to the instructions.

Work included in tasks, such as data and instructions, may be produced by a producer 116. Producer 116 may be included within CPU 102 or CUs 106 or any other processor that generates work for processing on CUs 102. In an embodiment, producer 116 generates work that scheduler 112 stores into tasks.

Although GPU 104 processes applications that involve a high degree of parallelism, in some embodiments, GPU 104 may also process applications that include control instructions and data dependencies that are conventionally processed using CPU 102. One of the reasons conventional GPUs execute applications that include parallel data (and not control instructions and data dependencies) is task scheduling. Typically, tasks are scheduled on a conventional GPU such that tasks are loaded into conventional CUs and are processed in parallel. Because, control instructions and data dependencies cannot be processed in parallel they are conventionally processed by CPU 102.

In an embodiment, channel 114 stores tasks that are scheduled for processing on CUs 106. Channel 114 may be an on-chip or off chip memory space accessible to GPU 104, An on-chip memory space is located on the same memory chip as GPU 104, whereas the off-chip memory space is located outside of the GPU 104. In an embodiment, channel 114 may be accessible to GPU 104, or to CPU 102 and GPU 104.

Memory space that includes channel 114 may be volatile and non-volatile memory. Example volatile memory includes a random access memory (RAM). Volatile memory typically stores data as long as electronic device receives power, as described above. Example non-volatile memory includes read-only memory, flash memory, ferroelectric RAM (F-RAM), hard disks, floppy disks, magnetic tape, optical discs, etc. Non-volatile memory retains its memory state when the electronic device loses power or is turned off. In an embodiment, data in the non-volatile memory may be copied to the volatile memory prior to being accessed by the components in a hardware pipeline.

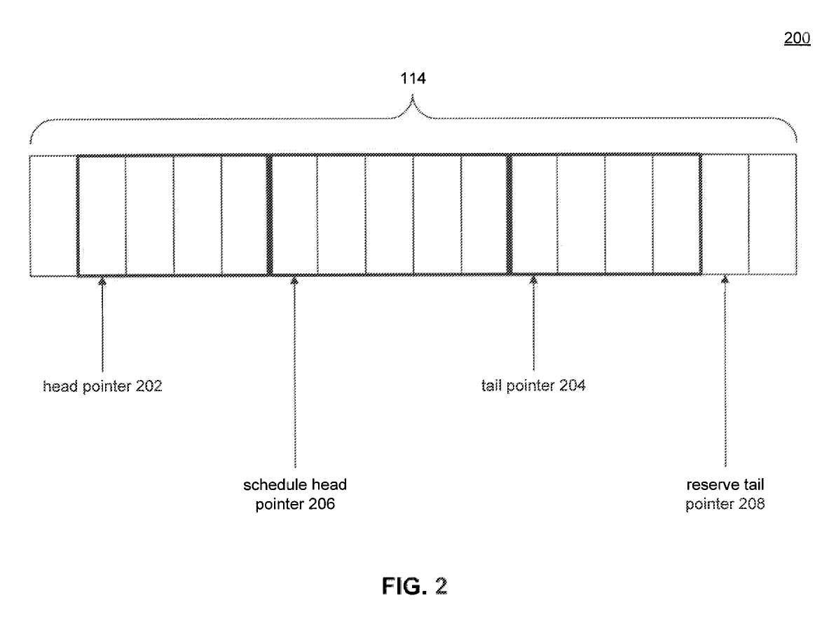

FIG. 2 is an exemplary embodiment 200 of a channel. Channel 114 stores data items within tasks that require processing on CUs 106. Channel 114 includes a head pointer 202, a tail pointer 204, a schedule head pointer 206 and a reserve tail pointer 208.

In an embodiment, data items between head pointer 202 and schedule head pointer 206 include data items that scheduler 112 has scheduled for processing by CUs 106, but that have not been released by CUs 106. These data items may be included in a hardware pipeline and are waiting to be dispatched by hardware dispatcher 110 to CUs 106. Once CU 106 reads a data item from hardware pipeline, hardware dispatcher 110 moves head pointer 202 to the next task in the hardware pipeline that is in queue for processing. In an embodiment, head pointer 202 moves toward schedule head pointer 206.

In an embodiment, schedule head pointer 206 points to a first data item that is in queue for being scheduled to the hardware pipeline. For example, data items between schedule head pointer 206 and tail pointer 204 are stored in channel 114 prior to being scheduled to the hardware pipeline by scheduler 112. As described above, scheduler 112 may schedule data items of a task between head pointer 206 and tail pointer 204 as programmed by a developer. Once scheduler 112 schedules data items to the hardware pipeline, scheduler 112 moves schedule head pointer 206 towards tail pointer 204.

In an embodiment, a memory space between tail pointer 204 and reserve tail pointer 208 is the memory space allocated to store data items within tasks. This memory space, however, has not been filled with data. For example, when scheduler 112 or producer 116 has allocated memory space in channel 114, but has not produced the data that will be stored in the allocated memory. In an embodiment, when producer 116 allocates memory space in channel 114, reserve tail pointer 208 may be moved to the last data item for which the memory was allocated. In this way, reserve tail pointer 208 identifies the last (also referred to as the newest data item) in channel 114.

Channel 114 may be a finite channel implemented as a circular queue. In a circular queue, pointers 202-208 are incremented to iterate over the same memory space, as long as tail pointer 204 does not pass head pointer 202. Because channel 114 is a circular queue, scheduler 112 iterates pointers 202-208 in a circle as tasks are de-queued when processed by CUs 106 and en-queued when produced by producers 116.

In a system that includes multiple CUs 106 within GPU 104 further enhancements are made to channel 114. For example, a bottleneck may occur as producers 116 write data to channel 114 and CUs 106 read tasks that scheduler 112 dispatched to the hardware pipeline for processing on GPU 104. A bottleneck may occur, when, for example, to maintain the data integrity of channel 114, CUs 106 and other components within GPU 104 and CPU 102 access the memory space in channel 114 using atomic operations. A person skilled in the art will appreciate that in an atomic operation, a single process can access a designated memory space at a time.

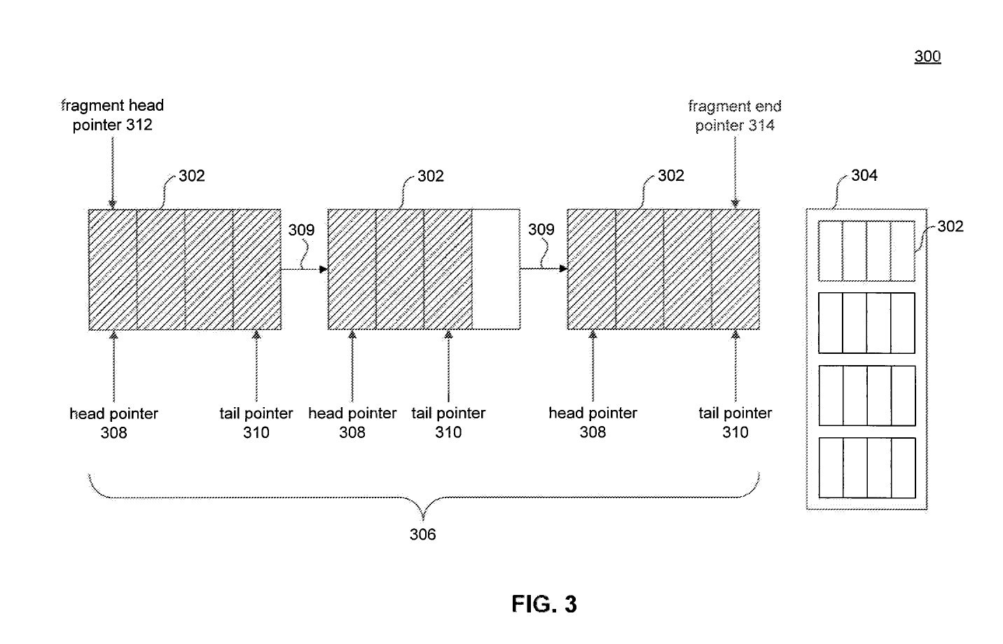

To alleviate the bottleneck, channel 114 may be fragmented into multiple channels. FIG. 3 is a block diagram 300 of a channel comprising multiple channel fragments, according to an embodiment. In block diagram 300, channel 114 is fragmented into multiple channels fragments 302 (also referred to channels 302). Channels 302 are created by allocating memory in a memory space accessible to GPU 104 and scheduler 112, such as cache memory in one example. In an embodiment, the size of channel 302 may be a multiple of a cache line size, where the multiple is pre-configured in cache memory. A person skilled in the art will appreciate that a cache line size is a fixed, variable or dynamically allocated memory block size for transferring data between different components in a computing environment.

In one embodiment, each channel 302 may be the same memory size as other channels 302. In another embodiment, the memory size of each channel 302 may be different from other channels 302.

Channels 302 are stored in a channel pool 304. Channel pool 304 includes unassigned channels 302. When scheduler 112 identifies that producer 116 produced data that requires processing by CU 106, it selects channel 302 from channel pool 304. Producer 116 then stores or en-queues data items from one or more tasks in the retrieved channel 302. Once data items are stored in channel 302, scheduler 112 assigns channel 302 to a particular CU 106. CU 106 then reads and processes data items from the associated channel 302. This allows each CU 106 to read tasks from the associated channel 302 without contention with other CUs 106 and channels 302.

In an embodiment, when there are more data items from a task that require processing by a particular CU 106 than the memory space included in channel 302, scheduler 112 may retrieve multiple channels 302 from channel pool 304 for producer 116 to store data items on the retrieved channels 302. Scheduler 112 then associates multiple channels 302 with a particular CU 106.

Each channel 302 includes a head pointer 308, a tail pointer 310 and a channel pointer 309. Head pointer 308 points to a first data item that scheduler 112 will schedule for processing by CU 106. When CU 106 reads data from the associated channel 302, CU 106 moves head pointer 308 to the next data item that requires processing.

Tail pointer 310 points to the last data item scheduled for processing in channel 302. In an embodiment, when producer 116 adds a data item to channel 302, scheduler 112 moves tail pointer 310 of channel 302 to the last data item en-queued in channel 302.

In an embodiment, each channel 302 is a circular queue, where head pointer 308 and tail pointer 310 iterate over the same memory space, such that tail pointer 310 does not pass head pointer 308.

In an embodiment, channel 114 may be a linked list of fragmented channels 302, such as list 306. In a linked list, channels 302 are connected to each other using a pointer. For example, channel pointer 309 connects channels 302 with each other to form list 306.

In an embodiment, list 306 includes a fragment head pointer 312 and a fragment tail pointer 314. Fragment head pointer 312 points to a first channel 302 in list 306. In an embodiment, fragment head pointer 312 points to a location of the first data item in channel 312 that is scheduled for processing by CU 106. In an embodiment, fragment head pointer 312 may point to the same memory address as schedule head pointer 206 in channel 114.

Fragment end pointer 314 points to the last channel 302 in list 306. In an embodiment, fragment end pointer 314 points to the last data item in the last channel 302 that was scheduled for processing. In an embodiment, fragment end pointer 314 points to the same memory address as tail pointer 204 in channel 114.

In an embodiment, list 306 is a linked list implemented as a circular queue that includes multiple channels 302, where each channel 302 is also a circular queue.

In another embodiment, each channel 302 may also include a schedule head pointer and a reserve tail pointer (not shown). As with channel 114, schedule head pointer may include data items that scheduler 112 has scheduled for processing by CUs 106, but that have not been released by CUs 106. Also, as with channel 114, a reserve tail pointer in channel 302 points to a last data item for which memory space was allocated but has not yet been filled with data.

Scheduler 112 adds channels 302 to list 306. In one embodiment, scheduler 112 includes channel 302 in list 306 when the memory space in channel 302 fills up with tasks. In another embodiment, scheduler includes channel 302 in list 306 when tasks are written to channel 302, but channel 302 is not full. This may occur, for example, when scheduler 112 determines that it is more efficient to process tasks in channel 302 then wait for the memory space in channel 302 to fill up.

In an embodiment, once scheduler 112 adds channel 302 to list 306, channel 302 becomes a read-only channel. Once channel 302 becomes a read-only channel, data items may be read from channel 302, but additional data items cannot be en-queued to channel 302.

In another embodiment, scheduler 112 may preempt the processing of data items in channels 302. For example, scheduler 112 can schedule CUs 106 to process channels 302 out of order, such that data items from tasks that have a higher priority are processed first. In this embodiment, scheduler 112 associates channel 302 having a higher priority with a particular CU 106 and inserts channel 302 having the higher priority in front of other channels 302 associated with the same CU 106.

When CU 106 processes a data item, the data in the data item is assigned to multiple lanes in CU 106. Each lane within CU 106 is an execution element that processes data in parallel with the other execution elements using the same or different set of instructions. Additionally, each CU 106 has its own local memory cache that stores data accessible to multiple execution elements. This allows the execution elements within CU 106 to communicate with each other to synchronize the processing of the data items.

As CUs 106 process data items within tasks, producers 116 may produce more data items that require processing. In this embodiment, scheduler 112 or producer 116 may allocate memory space within the same or different channel 302 to schedule new tasks.

In an embodiment, once CU 106 completes processing data items in channel 302, scheduler 112 may return channel 302 to channel pool 304.

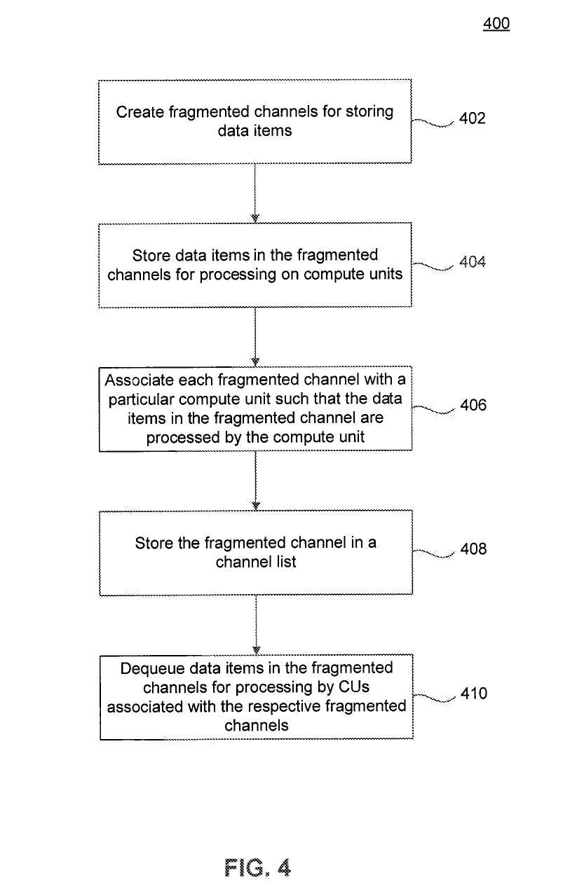

FIG. 4 is a flowchart of a method 400 for processing tasks using fragmented channels, according to an embodiment.

At operation 402, fragmented channels are created. In an embodiment, memory space for channels 302 is allocated. Channels 302 are then stored in channel pool 304, such that channels 302 are accessible to scheduler 112. As described above, each channel 302 includes a head pointer 308 and a tail pointer 310 for identifying the memory space within channel 302 that includes tasks. Additionally, channel 302 includes a channel pointer 309 for linking channels 302 in list 306.

At operation 404, data items from a task are stored in channels. As described above, scheduler 112 selects channels 302 from channel pool 304 so that producer 116 can store data items from tasks in channels 302.

At operation 406, a channel is associated with a particular CU. For example, scheduler 112 associates each channel 302 with CU 106. As described above, once channel 302 is associated with CU 106, data items that are included in channel 302 are processed using the associated CU 106.

At operation 408, channels are stored in list 306. For example, channels 302 are stored in list 306 that is accessible to scheduler 112. As described herein, list 306 includes a fragment head pointer 312 and fragment tail pointer 314 that keep track of channels 302 in list 306.

At operation 410, data items are de-queued for processing by CUs. For example, CUs 106 read data items from tasks scheduled for processing in channels 302, where each channel 302 is associated with a respective CU 106. CUs 106 then process the data items.

Embodiments can be accomplished, for example, through the use of general-programming languages (such as C or C++), hardware-description languages (HDL) including Verilog HDL, VHDL, Altera HDL (AHDL) and so on, or other available programming and/or schematic-capture tools (such as circuit-capture tools). The program code can be disposed in any known computer-readable medium including semiconductor, magnetic disk, or optical disk (such as CD-ROM, DVD-ROM). As such, the code can be transmitted over communication networks including the Internet and internets. It is understood that the functions accomplished and/or structure provided by the systems and techniques described above can be represented in a core (such as a CPU core and/or a GPU core) that is embodied in program code and may be transformed to hardware as part of the production of integrated circuits.

In this document, the terms “computer program medium” and “computer-usable medium” are used to generally refer to media such as a removable storage unit or a hard disk drive. Computer program medium and computer-usable medium can also refer to memories, such as system memory and graphics memory which can be memory semiconductors (e.g., DRAMs, etc.). These computer program products are means for providing software to an APD.

The embodiments are also directed to computer program products comprising software stored on any computer-usable medium. Such software, when executed in one or more data processing devices, causes a data processing device(s) to operate as described herein or, as noted above, allows for the synthesis and/or manufacture of computing devices (e.g., ASICs, or processors) to perform embodiments described herein. Embodiments employ any computer-usable or -readable medium, and any computer-usable or -readable storage medium known now or in the future. Examples of computer-usable or computer-readable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano-technological storage devices, etc.), and communication mediums (e.g., wired and wireless communications networks, local area networks, wide area networks, intranets, etc.).

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described exemplary embodiments, but should be defined only in accordance with the following claims and their equivalents.

What is claimed is:

1. A system comprising:
a plurality of fragmented channels stored in memory and accessible to a plurality of compute units, wherein a fragmented channel is associated with a compute unit in the plurality of compute units, and the fragmented channel is configured to:
store a plurality of data items from tasks scheduled for processing on the associated compute unit; and
link to another fragmented channel in the plurality of channels.

2. The system of claim 1, wherein the fragmented channel includes a head pointer pointing to a next data item that requires processing by the associated compute unit.

3. The system of claim 1, wherein the fragmented channel includes a tail pointer pointing to a last data item that requires processing by the associated compute unit.

4. The system of claim 1, wherein the fragmented channel is a circular queue.

5. The system of claim 1, wherein the plurality of fragmented channels are a circular queue and wherein each fragmented channel in the plurality of fragmented channels is another circular queue.

6. The system of claim 1, further comprising:
a scheduler configured to:
select the fragmented channel to en-queue a data item in the fragmented channel for processing on the associated computer unit; and
manipulate a reserve tail pointer to en-queue the data item on the selected fragmented channel.

7. The system of claim 1, further comprising
a scheduler configured to:
select the fragmented channel to de-queue a data item stored in the fragmented channel, wherein the de-queued data item is processed by the associated computer unit; and
manipulate a head pointer to de-queue the data item in the selected fragmented channel.

8. A method comprising:
storing on a fragmented channel a plurality of data items from tasks scheduled for processing on an associated compute unit, wherein the fragmented channel is included in a plurality of fragmented channels accessible to a plurality of compute units; and
linking the fragmented channel to another fragmented channel in the plurality of channels.

9. The method of claim 8, wherein the fragmented channel includes a head pointer pointing to a next data item that requires processing by the associated compute unit.

10. The method of claim 8, wherein the fragmented channel includes a tail pointer pointing to a last data item that requires processing by the associated compute unit.

11. The method of claim 8, wherein the fragmented channel is a circular queue.

12. The method of claim 8, wherein the plurality of fragmented channels are a circular queue and wherein each fragmented channel in the plurality of fragmented channels is another circular queue.

13. The method of claim 8, further comprising:
selecting the fragmented channel to en-queue a task for processing on the associated computer unit; and
manipulating a reserve tail pointer to en-queue the task on the selected fragmented channel.

14. The method of claim 8, further comprising
selecting the fragmented channel to de-queue a task stored in the fragmented channel, wherein the de-queued data item is processed by the associated computer unit; and
manipulating a head pointer to de-queue the data item in the selected fragmented channel.

15. A computer-readable storage medium having instructions stored thereon, execution of which by a processor cause the processor to perform operations, the operations comprising:
storing on a fragmented channel a plurality of data items from tasks scheduled for processing on an associated compute unit, wherein the fragmented channel is included in a plurality of fragmented channels accessible to a plurality of compute units; and
linking the fragmented channel to another fragmented channel in the plurality of channels.

16. The computer-readable storage medium of claim 15, wherein the fragmented channel includes a head pointer pointing to a next data item that requires processing by the associated compute unit.

17. The computer-readable storage medium of claim 15, wherein the fragmented channel includes a tail pointer pointing to a last data item that requires processing by the associated compute unit.

18. The computer-readable storage medium of claim 15, wherein the plurality of fragmented channels are a circular queue and wherein each fragmented channel in the plurality of fragmented channels is another circular queue.

19. The computer-readable storage medium of claim 15, further comprising:
selecting the fragmented channel to en-queue a data item for processing on the associated computer unit; and
manipulating a tail pointer to en-queue the data item on the selected fragmented channel.

20. The computer-readable storage medium of claim 15, farther comprising
selecting the fragmented channel to de-queue a data item from the fragmented channel, wherein the de-queued task is processed by the associated computer unit; and
manipulating a head pointer to de-queue the data item in the selected fragmented channel.
